(19) United States
(12) Patent Application Publication
(10) Pub. No.: US 2003/0151243 A1
(43) Pub. Date: Aug. 14, 2003

(54) Mud flap with decorative panel

(75) Inventor: Ehreth Horinek, Westlock (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Precision Design & Manufacturing Inc.

(21) Appl. No.: 10/368,663

(22) Filed: Feb. 14, 2003

(30) Foreign Application Priority Data
Feb. 14, 2002 (CA) 2,371,615

(51) Int. Cl. B62D 25/16

(52) U.S. Cl. 280/848

(57) ABSTRACT

A mud flap with decorative panel having a mounting face and a peripheral edge. A flange extends outwardly from the mounting face along substantially all of the peripheral edge. A flap body is provided having grooves adapted to receive the flange of the decorative panel. The flange of the decorative panel engages the grooves of the flap body to prevent debris from infiltrating between the mud flap and the decorative panel.

### FIELD OF THE INVENTION

The present invention relates to a mud flap with a decorative panel.

### BACKGROUND OF THE INVENTION

A mud flap is used to intercept mud, rocks and other debris thrown from a wheel of a vehicle. The body of the mud flap is, typically, made from rubber or plastic. In order to enhance the aesthetic appearance of the mud flap, decorative metal panels are bolted onto the rubber or plastic mud flap body. Debris tends to accumulate between the decorative panel and the rubber or plastic body.

### SUMMARY OF THE INVENTION

What is required is a mud flap with decorative panel that is not as prone to debris build up.

According to the present invention there is provided a mud flap with decorative panel. The decorative panel has a mounting face and a peripheral edge. A flange extends outwardly from the mounting face along substantially all of the peripheral edge. A flap body is provided having grooves adapted to receive the flange of the decorative panel.

With the mud flap, as described above, the flange of the decorative panel engages the grooves of the flap body to prevent debris from infiltrating between the mud flap and the decorative panel.

In keeping with industry standards, it is preferred that the flap body be formed from one of plastic or rubber.

Although beneficial results may be obtained through the use of the mud flap, as described above, aesthetics are even further improved when panel threaded receptacles are moulded into the flap body to receive attachment bolts.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an exploded perspective view of a mud flap with decorative panel fabricated in accordance with the teachings of the present invention.

FIG. 2 is a front elevation view of the mud flap illustrated in FIG. 1.

FIG. 3 is a side elevation view, in section, of the mud flap illustrated in FIG. 2.

FIG. 4 is a detailed side elevation view, in section, of the integrally moulded panel with threaded receptacles which are adapted to receive attachment bolts from the mud flap illustrated in FIG. 3.

### DETAILED DESCRIPTION OF THE PREFERRED EMBODIMENT

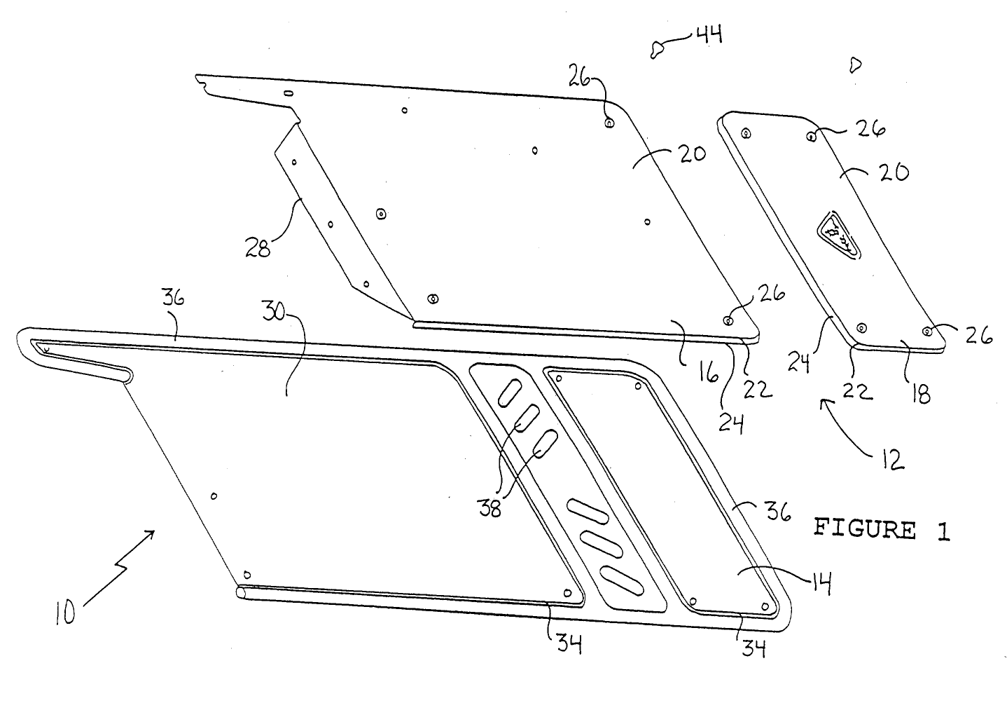

The preferred embodiment, a mud flap with decorative panels generally identified by reference numeral 10, will now be described with reference to FIGS. 1 through 4.

Structure and Relationship of Parts:

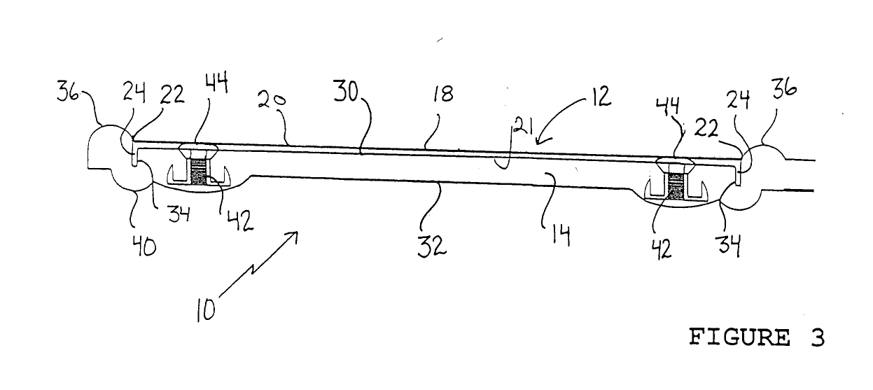

Referring to FIG. 1, there is provided a mud flap 10 that includes two rigid decorative panels, generally referenced by numeral 12, and a flap body 14. In order to distinguish between decorative panels 12, they will be identified as first panel 16 and a second panel 18. Although two are illustrated, it will be appreciated that there could be a single panel or more than two panels. Each of first panel 16 and second panel 18 have a decorative face 20, an underlying mounting face 21 and a peripheral edge 22. Referring to FIG. 3, a flange 24 extends outwardly from mounting face 21 along substantially all of peripheral edge 22 of both first panel 16 and second panel 18. Each of first panel 16 and second panel 18 have attachment bolt receiving apertures 26. First panel 16 has an additional angled lip 28 to assist in mounting of flap body 14.

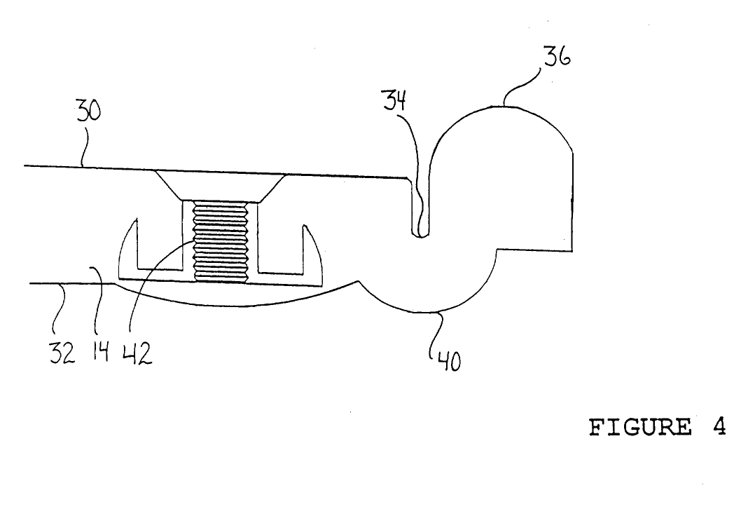

Referring to FIG. 3, flap body 14 is formed from either plastic or rubber and has a front side 30 and a back side 32. Referring to FIG. 1, front side 30 of flap body 14 has grooves 34 adapted to receive flange 24 of decorative panels 12. Front side 30 has a first raised ridge 36 that is positioned adjacent to grooves 34. Several raised flow guides 38 are formed on front side 30 of flap body 14 between first portion 16 and second portion 18 of decorative panel 12. Referring to FIG. 3, back side 32 has a second raised ridge 40 to provide more material into which groove 34 extends. Panel attachment bolt receiving receptacles 42 are moulded into flap body 14. This is shown in enlarged view in FIG. 4

Operation:

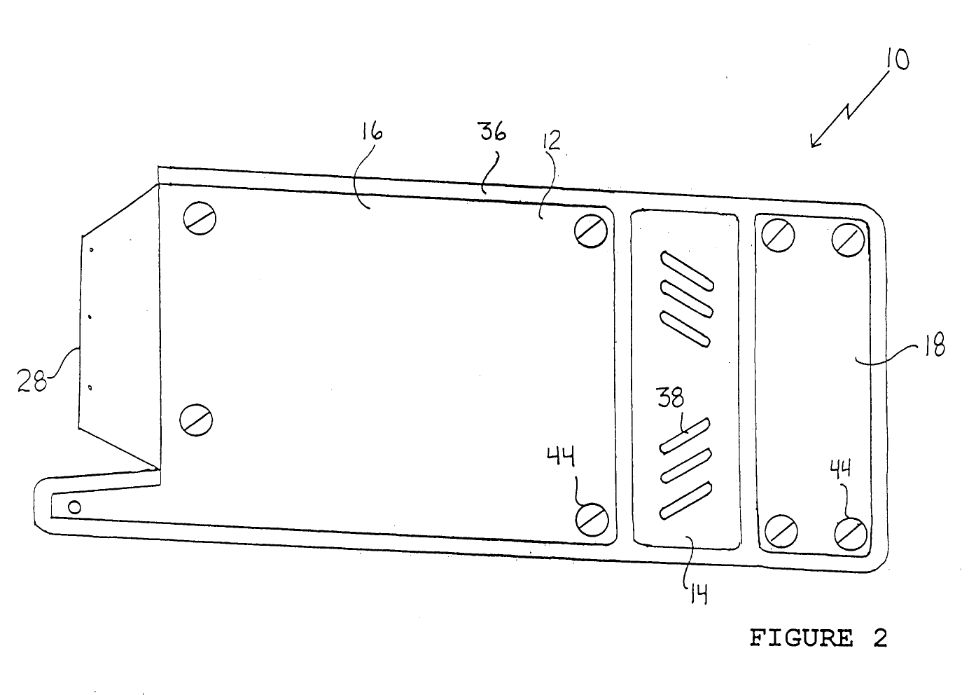

The use and operation of mud flap with decorative panels generally identified by reference numeral 10, will now be described with reference to FIGS. 1 through 4. Referring to FIGS. 2 and 3, first panel 16 and second panel 18 of decorative panel 12 are positioned so that flange 24 engages groove 34 on flap body 14. Bolts 44 are used to secure first panel 16 and second panel 18 to flap body 14 by extending through bolt receiving apertures 26 in first panel 16 and second panel 18 and threadably engaging with panel attachment bolt receiving receptacles 42 in flap body 14.

First raised ridge 36 serves to interfere with the entry of debris into groove 34. Second raised ridge 40 serves to maintain the thickness of flap body 14 and therefore reduce the possibility that groove 34 could weaken the integrity of flap body 14 and cause flap body 14 to tear. Raised flow guides 38 serve to guide flowing debris off of mud flap with decorative panel 10. Angled lip 28 on first portion 16 of decorative panel 12 is adapted to be attached to a vehicle.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A mud flap with decorative panel, comprising:
a rigid decorative panel having a mounting face and a peripheral edge,
a flange extending outwardly from the mounting face along substantially all of the peripheral edge; and
a flap body having grooves adapted to receive the flange of the decorative panel.

2. The mud flap as defined in claim 1, wherein the flap body is formed from one of plastic or rubber.

3. The mud flap as defined in claim 1, wherein panel threaded bolt receiving receptacles are moulded into the flap body.
